(19) United States
(12) Patent Application Publication
(10) Pub. No.: US 2020/0053315 A1
(43) Pub. Date: Feb. 13, 2020

(54) METHOD AND APPARATUS FOR ASSISTING A TV USER

(71) Applicant: Sony Corporation, Tokyo (JP)

(72) Inventors: David Young, San Diego, CA (US); Lindsay Miller, San Diego, CA (US); Lobrenzo Wingo, San Diego, CA (US); Marvin DeMerchant, San Diego, CA (US)

(73) Assignee: Sony Corporation, Tokyo (JP)

(21) Appl. No.: 16/102,639

(22) Filed: Aug. 13, 2018

(51) Int. Cl. H04N 7/14; H04N 5/445; G10L 15/22; G06K 9/00; H04N 5/50

(52) U.S. Cl. CPC H04N 7/147; H04N 5/44513; G10L 15/22; G10L 2015/223; H04N 5/50; H04N 2005/44521; G06K 9/00691

(57) ABSTRACT

A TV interacts with a robot. The robot can move around in a location. The TV has a camera, an image processor, a microphone, a loudspeaker, a voice assistant, and a wireless transceiver. The TV communicates with the robot and other devices, issues commands to the robot, and receives remote images and sounds from the robot. It also communicates with the user. The TV monitors local and remote sounds and images, and recognizes objects, beings, and situations. The TV monitors the user directly and via the robot. The TV accepts user commands to change the status of a selected object, being, or situation.

### CROSS REFERENCES TO RELATED APPLICATIONS

This application is related to U.S. patent application Ser. No. ______, entitled “Method & Apparatus for Assisting an autonomous robot”, filed on ______, (Attorney Ref. 020699-112710US/Client Ref. 201805922.01) which is hereby incorporated by reference, as if set forth in full in this specification.

This application is further related to U.S. patent application Ser. No. ______, ______, filed on filed on ______, (Attorney Ref. 020699-112720US/Client Ref. 201805934.01) which is hereby incorporated by reference, as if set forth in full in this specification.

### BACKGROUND

The present invention is in the field of smart homes, and more particularly in the field of television, robotics and voice assistants.

There is a need to provide useful, robust and automated, services to a person. Many current services are tied to the television (TV) and, therefore, only provided or useful if a user or an object of interest is within view of stationary cameras and/or agents embedded in or stored on the TV. Other current services are tied to a voice assistant such as Alexa, Google Assistant, and Siri. Some voice assistants are stationary, others are provided in a handheld device (usually a smartphone). Again, usage is restricted when the user is not near the stationary voice assistant or is not carrying a handheld voice assistant. Services may further be limited to appliances and items that are capable of communication, for instance over the internet, a wireless network, or a personal network. A user may be out of range of a TV or voice assistant when in need, or an object of interest may be out of range of those agents.

One example of an object of interest is an appliance such as a washing machine. Monitoring appliances can be impossible or very difficult because of the above described conditions. Interfacing the TV with the appliance electronically may be very difficult, for example when the appliance is not communication-enabled. Thus, while at home watching TV, people tend to forget about appliances that are performing household tasks. Sometimes an appliance can finish a task and the user wants to know when it is done. Other times an appliance may have a problem that requires a user's immediate attention. The user may not be able to hear audible alarms or beeps from the appliance when watching TV in another room.

A further problem is that currently available devices and services offer their users inadequate help. For example, a user who comes home from work may have a pattern of turning on a TV and all connected components. Once the components are on, the user may need to press multiple buttons on multiple remote controls to find desired content or to surf to a channel that may offer such content. Currently there are solutions for one-button push solutions to load specific scenes and groups of devices, but they do not load what the user wants immediately, and they do not help to cut down on wait time. Another example of inadequate assistance is during the occurrence of an important family event. Important or noteworthy events may occur when no one is recording audio/video or taking pictures. One participant must act as the recorder or photographer and is unable to be in the pictures without using a selfie-stick or a tripod and timer.

A yet further, but very common, problem is losing things in the home. Forgetting the last placement of a TV remote control, keys, phones, and other small household items is very common. Existing services (e.g., Tile) for locating such items are very limited or non-existent for some commonly misplaced items. One example shortcoming is that a signaling beacon must be attached to an item to locate it. The signaling beacon needs to be capable of determining its location, for example by using Global Positioning System (GPS). Communication may be via Bluetooth (BT), infra-red (IR) light, WiFi, etc. Especially GPS, but also the radio or optical link can require considerable energy, draining batteries quickly. GPS may not be available everywhere in a home, and overall the signaling beacons are costly and inconvenient. Many cellphones include a Find the Phone feature, which allows users to look up the GPS location of their phone or to ring it, if it is on and signed up for the service. However, for many reasons such services and beacons may fail. Further, it is quite possible to lose the devices delivering the location services.

Until now, there has not been a comprehensive solution for the above problems. Embodiments of the invention can solve them all at once.

### SUMMARY

There is a need to provide useful, robust and automated, services to a person. Many current services are tied to the television (TV) and, therefore, only provided or useful if a user or an object of interest is within view of stationary cameras and/or agents embedded in or stored on the TV. Embodiments of the invention overcome this limitation and provide a method and an apparatus for assisting a TV user.

In a first aspect, an embodiment provides a television (TV) capable of interacting with a robot. The TV and the robot are in a location, and the robot is capable of moving around in the location. The TV includes a camera for capturing local images, an image processor coupled to the camera, a microphone for capturing local sounds, a loudspeaker, a voice assistant coupled with the microphone and loudspeaker, and a wireless transceiver that is capable of performing two-way communication.

The TV is configured to:

(i) communicate with the robot via the wireless transceiver;

(ii) communicate and control other devices via the wireless transceiver;

(iii) communicate with a user via at least one of the voice assistant and the wireless transceiver;

(iv) issue commands to the robot;

(v) receive remote images and remote sounds streamed by the robot;

(vi) monitor the local images and remote images using the image recognition processor;

(vii) recognize objects of interest and beings using the image recognition processor;

(viii) monitor the local sounds and remote sounds in the voice assistant;

(ix) recognize situations based on results from the image recognition processor and the voice assistant; and

(x) monitor the user directly and via the robot.

In an embodiment, the TV is configured to receive information from the robot measured with one or more health status sensors. The TV may also be configured to receive information from sensors for at least one of ambient temperature, infrared light, ultra-violet light, smoke, carbon monoxide, humidity, location, and movement.

The TV may accept commands from an authorized being. A command may include a text, an interaction with a graphical user interface, a voice command, body language, or a gesture.

In a further embodiment, the TV is configured to receive a model of the location from the robot, and to recognize a change in the location. The TV may be configured to recognize, remember and report a placement of an object of interest. It is configured to report the placement of the object of interest to the user if the placement is not regular.

In a yet further embodiment, an object of interest is an appliance, and the TV identifies the state of the appliance and determines a priority for displaying the state and a priority for displaying other TV content, such as news or entertainment. The TV immediately displays the state to the user if the priority for displaying the state is higher than the priority for displaying other TV content.

In even further embodiments, the TV determines if a situation is regular or non-regular, and it takes actions based thereon and based on the type of situation. For example, if the situation includes an emergency, the TV seeks immediate help to mitigate the emergency and keep a being safe. It may also categorize, capture, record, and document the situation.

In a second aspect, an embodiment provides a method for a TV to interact with a robot. The method comprises the steps of receiving and recording a data stream, analyzing it to recognize an object, being, or situation, selecting a recognized object, being, or situation, and determining its status. The embodiment invites a user command based on the selection, and determines from a received user command if the status must be changed. If so, it changes the status directly or via the robot.

A further understanding of the nature and the advantages of particular embodiments disclosed herein may be realized by reference of the remaining portions of the specification and the attached drawings.

### BRIEF DESCRIPTION OF THE DRAWINGS

The invention is described with reference to the drawings, in which:

FIG. 1 illustrates a television (TV) capable of interacting with a robot according to an embodiment of the invention;

FIG. 2 illustrates communication between the TV and the robot according to embodiments of the invention;

FIG. 3 illustrates the TV monitoring a location according to an embodiment of the invention;

FIG. 4 illustrates a TV receiving user health information measured by a robot according to an embodiment of the invention;

FIG. 5 illustrates a TV accepting commands from an authorized user and rejecting commands from an unauthorized user according to an embodiment of the invention;

FIG. 6 illustrates a TV noticing an object of interest in an unusual place according to an embodiment of the invention;

FIG. 7 illustrates a TV monitoring appliances according to an embodiment of the invention;

FIG. 8 illustrates a TV recording a non-regular situation according to an embodiment of the invention; and

FIG. 9 illustrates a method for a TV to interact with a robot according to an embodiment of the invention.

### DETAILED DESCRIPTION

There is a need to provide useful, robust and automated, services to a person. Many current services are tied to the television (TV) and, therefore, only provided or useful if a user or an object of interest is within view of stationary cameras and/or agents embedded in or stored on the TV. Embodiments of the invention overcome this limitation and provide a method and an apparatus for assisting a TV user, as described in the following.

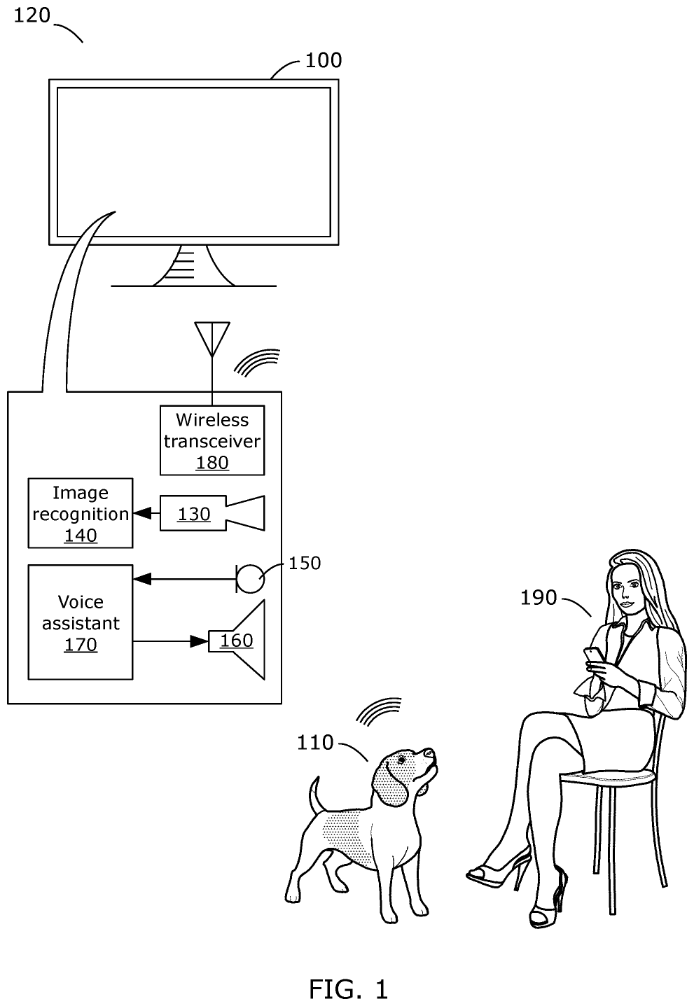

FIG. 1 illustrates a television (TV 100) capable of interacting with a robot 110 according to an embodiment of the invention. TV 100 and robot 110 may be situated in a location 120. TV 100 includes a camera 130 configured to capture local images, an image recognition processor 140 coupled to camera 130, a microphone 150 configured to capture local sounds, a loudspeaker 160, a voice assistant 170 coupled to the microphone 150 and the loudspeaker 160, and a wireless transceiver 180 capable of performing two-way communication.

Robot 110 may be autonomous, or partially or fully controlled by TV 100. Even if robot 110 is autonomous, TV 100 and robot 110 share a protocol that enables TV 100 to issue commands to robot 110, wherein the commands include implicit or explicit instructions for robot 110 to collect certain information, and to provide the certain information back to TV 100. Robot 110 includes sensors for at least one of ambient temperature, infrared light, ultra-violet light, smoke, carbon monoxide, humidity, location, and movement, and TV 100 is configured to receive and process information from the sensors. In embodiments, TV 100 uses the information to assist a user 190 as further detailed herein.

Robot 110 may be shaped like a human or other animal, e.g. Sony's doggy robot aibo, or like a machine that is capable of locomotion, including a vacuum cleaning robot, or like any other device that may be capable of assisting a TV user.

Location 120 may be building, a home, an apartment, an office, a yard, a shop, a store, or generally any location where a TV user may require assistance.

Voice assistant 170 may be or include a proprietary system, such as Alexa, Echo, Google Assistant, and Siri, or it may be or include a public-domain system. It may be a general-purpose voice assistant system, or it may be application-specific, or application-oriented.

Wireless transceiver 180 may be configured to use any protocol such as WiFi, Bluetooth, Zigbee, ultra-wideband (UWB), Z-Wave, 6LoWPAN, Thread, 2G, 3G, 4G, 5G, LTE, LTE-M1, narrowband IoT (NB-IoT), MiWi, and any other protocol used for RF electromagnetic links, and it may be configured to use an optical link, including infrared IR).

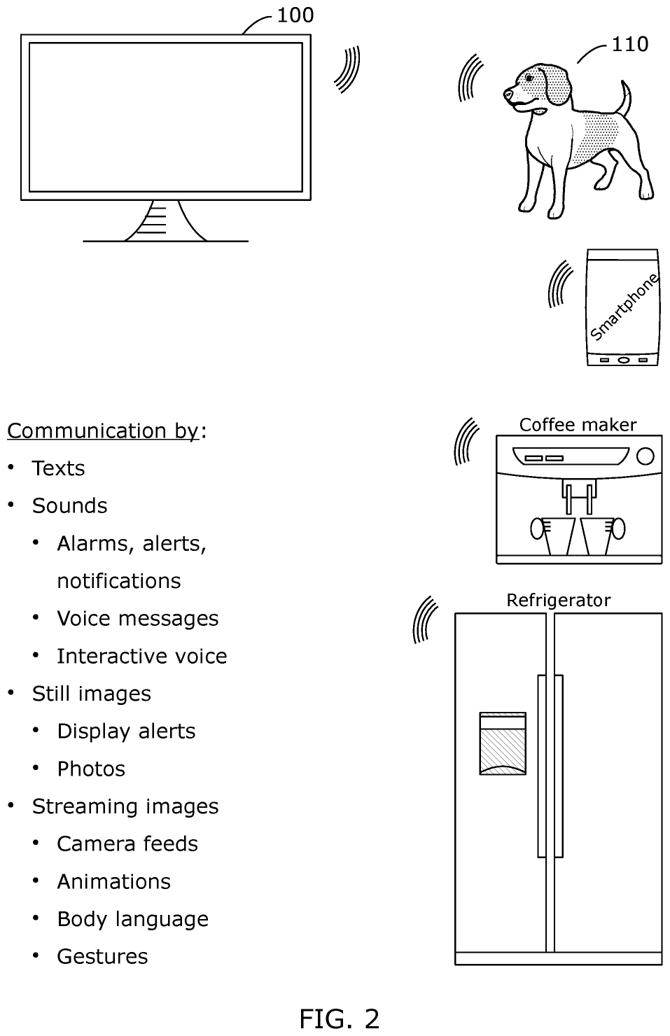

FIG. 2 illustrates communication between TV 100 and robot 110 according to embodiments of the invention. TV 100 is configured to communicate with robot 110 using wireless transceiver 180. It may receive remote images and remote sounds streamed by robot 110. It may further communicate and control other devices via wireless transceiver 180, such as appliances, including refrigerators, washing machines, dryers, dishwashers, ranges, microwaves, coffee makers, vacuum cleaners, and home systems including security, lighting, heating and air conditioning. It may also receive data from cameras, microphones, motion detectors, and other sensors via wireless transceiver 180.

TV 100 may be configured to communicate with user 190 in various ways. It may communicate using texts, sounds, and images. It may communicate directly using voice assistant 170, microphone 150 and loudspeaker 160. Embodiments may show user 190 information or alerts directly on a TV 100 screen, and may monitor user 190 for gestures, or body language in general, using camera 130 and image recognition processor 140. Further embodiments may use wireless transceiver 180 to communicate with user 190, for example when user 190 uses a Bluetooth or WiFi headset. Yet further embodiments may communicate with user 190 via robot 110, or via another third-party device, including via a mobile phone or smartphone, a tablet, or a computer. For example, in an embodiment, TV 100 may call user 190 via a mobile phone network and leave a voice message, a text message, a video message, another type of message, or it may talk with user 190. In an even further embodiment, TV 100 may command robot 110 to make a gesture to user 190. For example, it could command Sony's dog robot aibo to wag its tail or drop its ears.

TV 100 is configured to receive remote images and remote sounds streamed by robot 110. It forwards received remote images to image recognition processor 140 and received remote sounds to voice assistant 170. TV 100 uses image recognition processor 140 and voice assistant 170 to communicate with humans, and/or with animals in general. But also, using image recognition processor 140 and/or voice assistant 170, TV 100 recognizes and monitors beings and objects of interest, and aspects of location 120.

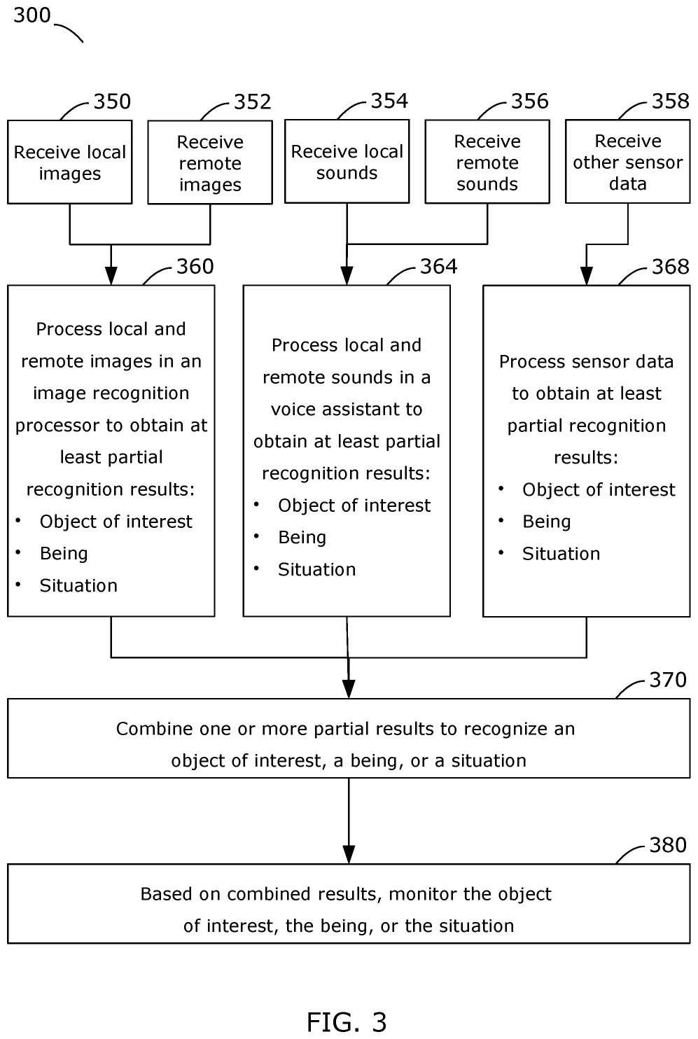

FIG. 3 illustrates method 300 for TV 100 monitoring location 120 according to an embodiment of the invention. TV 100 may monitor directly, using local images from its camera 130 and local sounds from microphone 150, or it may monitor indirectly, using remote information (including remote images and remote sounds) from external cameras, microphones and other sensors, for example those in robot 110, and/or those in security systems. Using image recognition processor 140 it associates still and streamed images with meaning, for example, it tags part of processed information as an object of interest, as a being, or as a situation. Using voice assistant 170 it associates sounds with meaning, for example, it may tag part of the sound as coming from the object of interest, the being, or the situation. An embodiment may also use partial results from both image recognition processor 140 and voice assistant 170 to associate data with meaning to recognize the object of interest, being, or situation.

An object of interest may comprise anything commonly found in the household of a user 190, or anything not commonly found but that is particular to user 190. In case location 120 is not a household but, for example, an office, the object of interest may comprise anything commonly or particularly found in the office. In case location 120 is not a household or an office, the object of interest may comprise anything commonly or particularly found in location 120. The being may comprise user 190, a family member, a friend, an acquaintance, a visitor, a pet, a co-worker, or any other human or animal of interest to user 190. The situation may be user-defined, or automatically defined based on artificial intelligence learning techniques. It may be a regular situation or a non-regular situation. The situation may be desired or undesired. It may include an emergency, a party, a burglary, a child's first steps, a wedding, a ceremony, a transgression, or any other event that is relevant to user 190.

Method 300 comprises the following steps.

Step 350—receiving local images from camera 130. An image may be still, or streaming. A still image may be a single image taken from a stream of images.
Step 352—receiving remote images from another source. Again, an image may be still or streaming. The other source may be robot 110, or some other device, appliance, or apparatus.
Step 354—receiving local sounds from microphone 150.
Step 356—receiving remote sounds from another source. The other source may be robot 110, or some other device, appliance, or apparatus.
Step 358 (optional)—receiving data from another sensor. The sensor may be included in robot 110 or in some other device, appliance, or apparatus. The sensor may measure ambient temperature, infrared light, ultra-violet light, smoke, carbon monoxide, humidity, location, movement, or any other physical quality that is relevant for assisting user 190. The sensor may be a health status sensor, for measuring a person's temperature, blood pressure, heart rate, blood oxygenation, brain activity, blood composition, or any other physical quality relevant to the person's health.
Step 360—processing local images from Step 350 and/or remote images from Step 352 in image recognition processor 140 to obtain at least partial results in recognizing an object of interest, a being, or a situation.
Step 364—processing local sounds from Step 354 and/or remote sounds from Step 356 in voice assistant 170 to obtain at least partial results in recognizing an object of interest, a being, or a situation.
Step 368—(optional) processing the data received in Step 358 to additional results in recognizing an object of interest, a being, or a situation.
Step 370—combining one or more at least partial results from steps 360-368 to obtain combined results in recognizing an object of interest, a being, or a situation. The combined results may be final or provisional. The combined results may include one or more candidate final results with probability information.
Step 380 (optional)—based on the combined results, monitoring the object of interest, the being, and/or the situation.

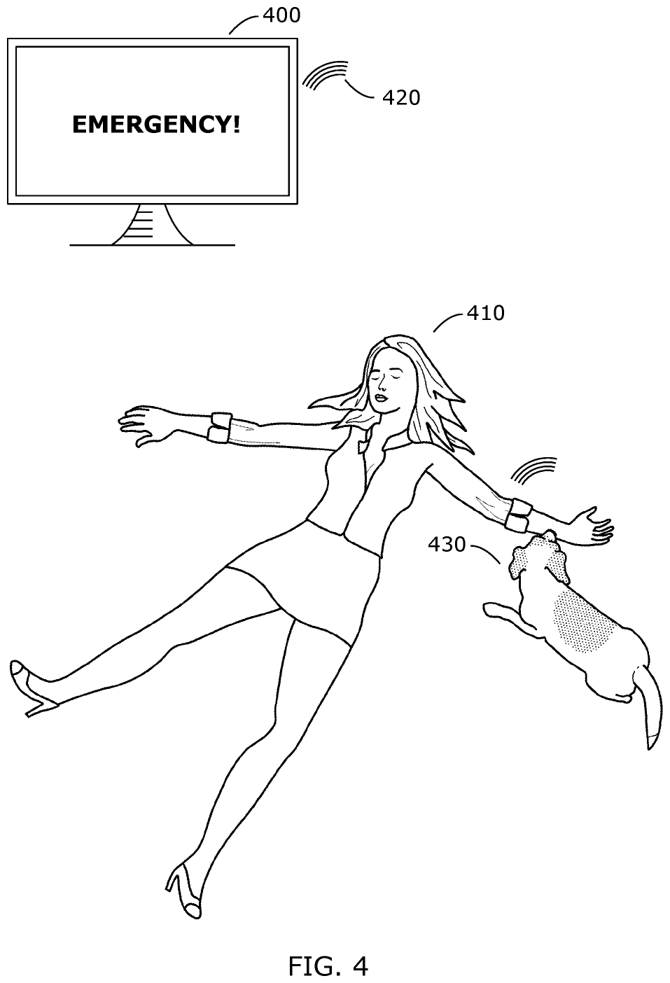

FIG. 4 illustrates a TV 400 receiving user 410 health information 420 measured by a robot 430 according to an embodiment of the invention. In this example situation, user 410 shows unexpected behavior or has asked TV 400 (possibly via robot 430) for help, and TV 400 has instructed robot 430 to check on user 410 and provide health information 420. The simplest form of health information 420 may include only visual information from a camera in robot 430, but a more sophistic robot 430 may include dedicated health status sensors, including for measuring a person's temperature, blood pressure, heart rate, blood oxygenation, brain activity, blood composition, or any other physical quality relevant to user 410's health. Robot 430 measures any health information 420 that it is equipped for to measure, and transmits it to TV 400. TV 400 determines that the situation is (or may be) an emergency, and start taking actions according to one or more emergency protocols. The protocols may include determining if the location is safe, determining if there are other beings in the location, alerting emergency responders, sounding alarms, and any other actions that are standard or non-standard protocol to help ensure or restore the safety and health of user 410. Determining if the location is safe may include checking for fires, flooding, dangerous temperatures, unknown or dangerous persons, or other irregularities in the location. Alerting emergency responders may include providing health information, providing voice and/or visual contact with user 410, and/or providing information about the location and beings in the location.

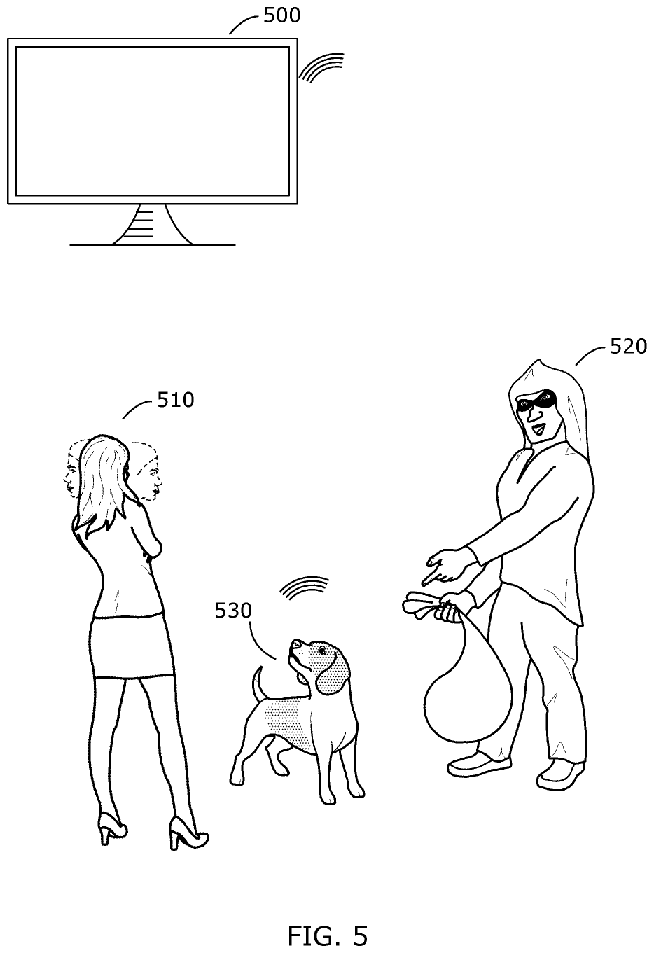

FIG. 5 illustrates a TV 500 accepting commands from an authorized user 510 and rejecting commands from an unauthorized user 520 according to an embodiment of the invention. TV 500 may receive the commands directly, or via robot 530. In this example situation, unauthorized user 520 demands to know the location of a certain object of interest, whereas authorized user 510 makes a gesture (shaking her head “no”) and exhibits body language rejecting the demand. TV 500 watches the gesture and body language, determines that it is coming from authorized user 510, and ignores conflicting demands coming from unauthorized user 520. In further embodiments, TV 500 ignores unauthorized user 520 even without rejection by authorized user 510.

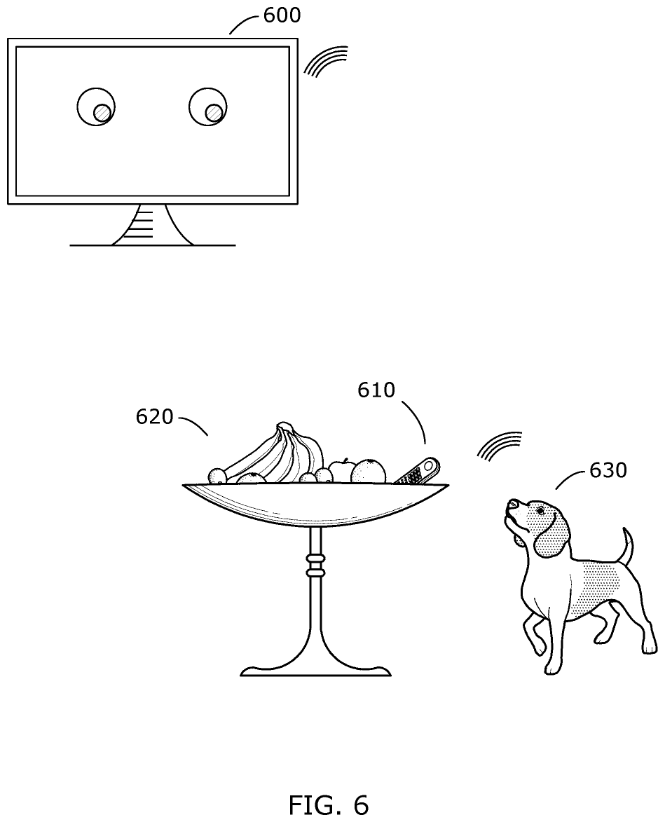

FIG. 6 illustrates a TV 600 noticing an object of interest 610 in an unusual place 620 according to an embodiment of the invention. TV 600 has ordered robot 630 to roam the location, and robot 630 streams images to TV 600, including those of object of interest 610, in this example a remote control unit. TV 600 recognizes object of interest 610 using an image recognition processor, and further recognizes that its placement is in unusual place 620, in this example a fruit basket. In some embodiments, TV 600 first recognizes a change in the location (e.g., the contents of the fruit basket being unregular), and subsequently recognizes the object of interest 610 (placed in the fruit basket). In other embodiments, TV 600 recognizes the object of interest 610, and determines that it is not in one of its usual placements. In further embodiments, TV 600 does not need information via robot 630, but can make the determination(s) alone, provided that object of interest 610 is in line of sight of its built-in camera, or of another camera that provides images to TV 600.

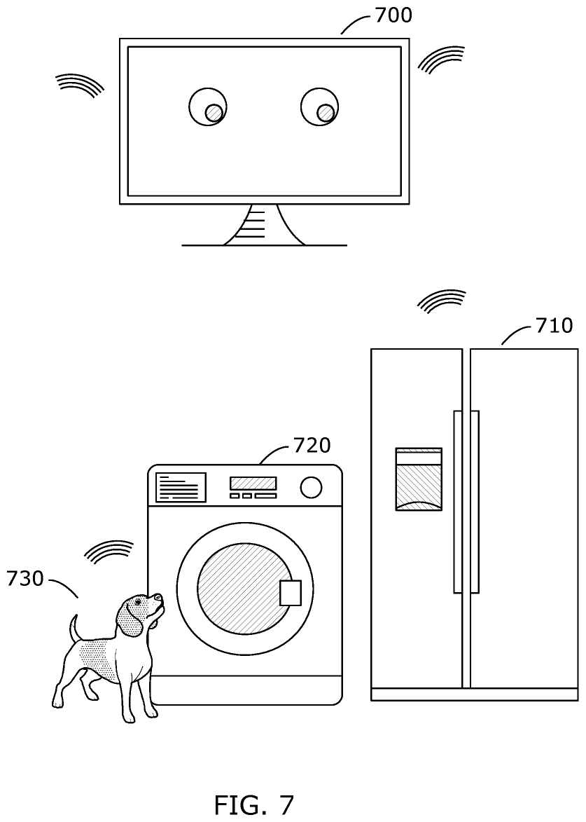

FIG. 7 illustrates a TV 700 monitoring appliances according to an embodiment of the invention. In this example embodiment, TV 700 directly monitors refrigerator 710, for example via its wireless transceiver, which may include a WiFi protocol. This embodiment requires the appliance (refrigerator 710) to be capable of detecting and measuring its content, and communicating information about detected and measured items and variables upon request. For example, refrigerator 710 may measure its internal temperature in one or more locations, and/or hold a log of such measurements. And it may detect the presence of certain items inside, for example using radio-frequency identification (RFID) or barcode scanning techniques. TV 700 also monitors washing machine 720. However, it does so not directly, but via robot 730. Robot 730 sends or streams images of washing machine 720 to TV 700, which inspects the images using an image recognition processor, and determines the status of washing machine 720 from the images. For example, the status information may include: “washing machine 720 is on and filled with laundry. It is executing program #3, and has 45 minutes to go.” TV 700 may monitor any communication-capable appliance directly using its wireless transceiver, as well as indirectly via robot 730 using its image recognition processor. It may monitor appliances that are not communication-capable via robot 730 using its image recognition processor.

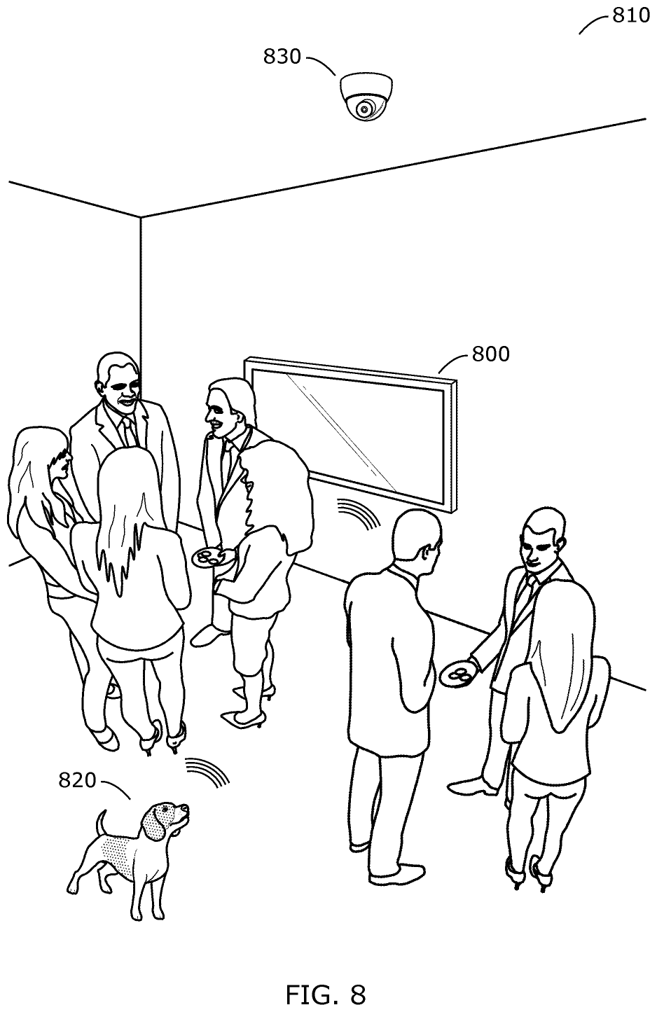

FIG. 8 illustrates a TV 800 recording a non-regular situation 810 according to an embodiment of the invention. TV 800 determines if non-regular situation 810 is desired. If not, it alerts the user. It categorizes, captures, records, and documents non-regular situation 810. It further determines if non-regular situation 810 is an emergency, and if so, it seeks immediate help to mitigate the emergency. Some embodiments accept commands from a provisionally authorized being, for example from an emergency responder, a known relative, or a known acquaintance. The example in FIG. 8 may depict a professional party, which is a desired situation, and TV 800 does not attempt to mitigate the situation. In the embodiment in the example non-regular situation 810, each TV 800, robot 820, and security camera 830 provide one or more video streams that TV 800 records and uses to document non-regular situation 810. Some embodiments may record any non-regular situation, whereas other embodiments may record select non-regular situations, or may request a user decision upfront or after the fact.

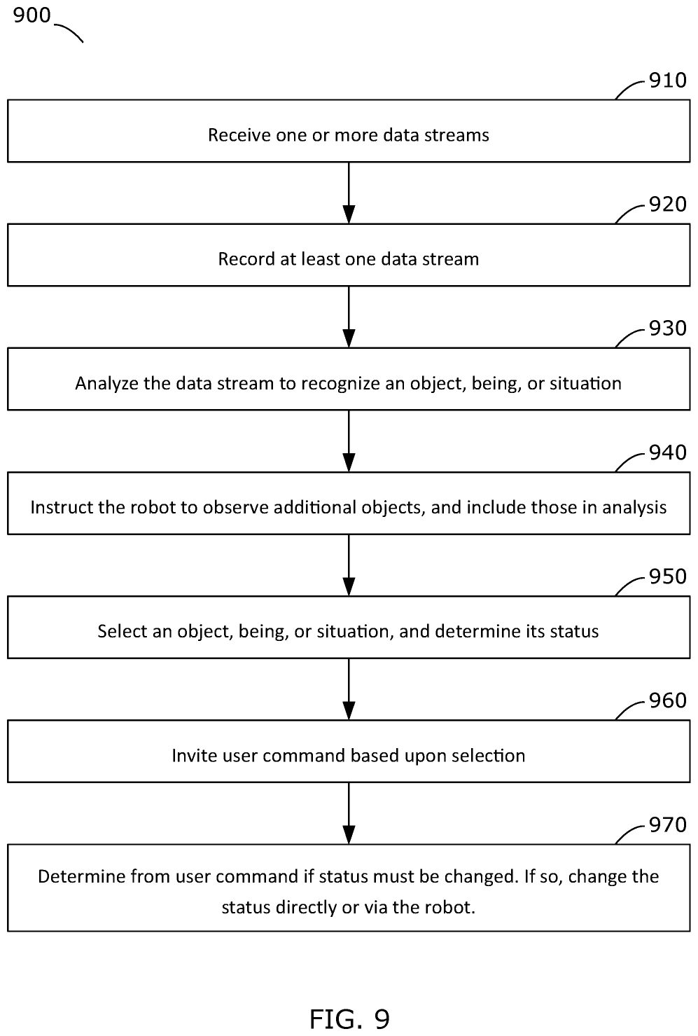

FIG. 9 illustrates a method 900 for a TV to interact with a robot according to an embodiment of the invention. Method 900 may involve one or more TVs acting in parallel, and one or more robots being controlled by one or more of the TVs. Method 900 comprises the following steps.

Step 910—Receiving one or more data streams. The data streams may include video and/or audio, and data from any other sensors configured to provide data to the TV. The data streams may come from a camera, microphone, or other sensor built into the TV, from a camera, microphone, or other sensor built into the robot, or from another external camera, microphone, or sensor.
Step 920—Recording at least one of the one or more data streams.
Step 930—Analyzing the at least one of the one or more data streams to recognize an object of interest, a being, and/or a situation. The TV uses an image recognition processor to analyze a video stream, and a voice assistant to analyze an audio stream.
Step 940—(Optional) Instructing the robot to observe additional objects around the object of interest, the being, and/or the situation. Including the additional objects in the analysis.
Step 950—Selecting one of a recognized object of interest, a being, and a situation, and determining its status.
Step 960—Inviting a user to command an action based upon the status and the selected object of interest, being, or situation.
Step 970—Upon receiving a user command, determining if the status must be changed, and upon determining that the status must be changed, changing the status. The TV may change the status directly, or may instruct the robot to change the status, or it may work with the robot to change the status.
Step 980—(Optional) Repeating steps 910-970.

Although the description has been described with respect to particular embodiments thereof, these particular embodiments are merely illustrative, and not restrictive. For example, the illustrations show a dog-shaped robot. However, any shape robot meets the spirit and ambit of the invention, and embodiments may work with a single robot or multiple robots, whatever their shape. The illustrations and examples show a single TV embodying the invention. However, embodiments may spread their methods over multiple TVs that act in parallel and in collaboration. Methods may be implemented in software, stored in a tangible and non-transitory memory, and executed by a single or by multiple processors. Alternatively, methods may be implemented in hardware, for example custom-designed integrated circuits, or field-programmable gate arrays (FPGAs). The examples distinguish between an image recognition processor and a voice assistant. However, the image recognition processor and the voice assistant may share a processor or set of processors, and only be different in the software executed, or in the software routines being executed.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable non-transitory storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general-purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A method for a TV to interact with a robot, comprising the following steps:
receiving one or more data streams, wherein the data streams may include at least one of video from a camera, audio from a microphone, and data from another sensor configured to provide data to the TV, and wherein a source of the data stream is included in one of the TV, the robot, and an external device;
recording at least one of the one or more data streams;
analyzing at least one of the one or more data streams to recognize at least one of an object of interest, a being, and a situation, and wherein analyzing a video stream is performed using an image recognition processor;
selecting one of a recognized object of interest, a recognized being, and a recognized situation, and, using the image recognition processor, determining a status of the recognized object of interest;
inviting a user to command an action based upon the status;
upon receiving a user command, determining if the status must be changed; and
upon determining that the status must be changed, changing the status.

20. The method of claim 19, wherein:
the object of interest is one of commonly found in a user household and particular to the user;
the being is one of the user, a family member, a relative, a friend, an acquaintance, a visitor, a co-worker, another human, a pet, and another animal; and
changing the status is performed directly by the TV, or indirectly by the robot.

21. The method of claim 19, wherein:
(a) the camera is configured to capture local images;
(b) the image recognition processor is coupled to the camera;
(c) the microphone is configured to capture local sounds;
and wherein the TV comprises:
(d) a loudspeaker;
(e) a voice assistant coupled with the microphone and the loudspeaker; and
(f) a wireless transceiver capable of performing two-way communication;
wherein the TV is configured to:
(i) communicate with the robot via the wireless transceiver;
(ii) communicate and control other devices via the wireless transceiver;
(iii) communicate with a user via at least one of a TV screen, the voice assistant and the wireless transceiver;
(iv) issue commands to the robot;
(v) receive remote images and remote sounds streamed by the robot;
(vi) monitor the local images and remote images using the image recognition processor;
(vii) recognize beings using the image recognition processor;
(viii) monitor the local sounds and remote sounds in the voice assistant;
(ix) recognize situations based on results from the image recognition processor and the voice assistant; and
(x) monitor the user directly and via the robot; and
wherein the robot is capable of moving around in a location.

22. The method of claim 19, wherein the TV is further configured to receive information from the robot measured with one or more health status sensors.

23. The method of claim 19, wherein the TV is further configured to receive information from sensors for at least one of ambient temperature, infrared light, ultra-violet light, smoke, carbon monoxide, humidity, location, and movement.

24. The method of claim 19, wherein the beings include at least one of the user, a family member, a friend, an acquaintance, a visitor, a co-worker, and a pet.

25. The method of claim 19, wherein the TV accepts commands from an authorized being.

26. The method of claim 19, wherein the command includes at least one of a text, an interaction with a graphical user interface, a voice command, body language, and a gesture.

27. The method of claim 19, wherein the TV is further configured to be taught by the user, through voice commands and vision, that an object comprises an object of interest.

28. The method of claim 21, further comprising using a model of the location to determine if a placement is regular, and upon determining that the placement is not regular, reporting the placement to the user.

29. The method of claim 28, wherein reporting the placement to the user comprises showing the user an image with a timestamp and a marker of the placement.

30. The method of claim 21, wherein the TV is configured to control the robot to scan the location, and configured to categorize and document objects viewed by the robot for documentation purposes.

31. The method of claim 19, further comprising monitoring the state of an object of interest.

32. The method of claim 31, wherein:
an object of interest is an appliance;
the TV identifies a state of the appliance and determines a priority for displaying the state and a priority for displaying content;
the state includes at least one of a finished task and a problem that requires user attention;
the TV immediately displays the state if the priority for displaying the state is higher than the priority for displaying the content; and
the TV delays displaying the state if the priority for displaying the state is lower than the priority for displaying the content.

33. The method of claim 19, wherein the recognized situation is one of user-defined, and automatically defined based on artificial intelligence learning techniques.

34. The method of claim 19, wherein the recognized situation is a regular situation; the TV is configured to anticipate one or more commands associated with the regular situation; and an anticipated command includes switching to a user-preferred channel.

35. The method of claim 19, wherein the recognized situation is a non-regular situation, and wherein the TV is configured to:
determine if the recognized situation is desired or undesired;
categorize, capture, record, and document the recognized situation;
determine if the recognized situation includes an emergency; and
upon determining that the recognized situation includes an emergency, seek immediate help to mitigate the emergency and accept commands from a provisionally authorized being, and wherein the provisionally authorized being includes one of an emergency responder, a known relative, and a known acquaintance.

36. The method of claim 35, wherein the recognized situation includes one of a party, a child's first steps, and a burglary.
